(19) United States
(12) Patent Application Publication
(10) Pub. No.: US 2014/0127640 A1
(43) Pub. Date: May 8, 2014

(54) DENTAL DRILL BIT SYSTEM AND METHOD

(71) Applicant: Zimmer Dental, Inc., Carlsbad, CA (US)

(72) Inventors: John Zacharia, San Diego, CA (US); Kim Nguyen, San Diego, CA (US)

(73) Assignee: Zimmer Dental, Inc., Carlsbad, CA (US)

(21) Appl. No.: 14/150,957

(22) Filed: Jan. 9, 2014

Related U.S. Application Data
(62) Division of application No. 13/403,488, filed on Feb. 23, 2012.

(51) Int. Cl. A61C 8/00; A61C 1/00; A61C 1/08; A61C 3/02

(52) U.S. Cl. CPC A61C 8/0089; A61C 3/02; A61C 1/0069; A61C 1/084
USPC 433/75; 433/173; 433/166; 433/82

(57) ABSTRACT

A dental drill is disclosed which allows for an osteotomy to be formed in a shape which closely matches the cylindrical shape of many dental implants. In so doing, the implant engages more tissue of the resulting osteotomy, thus resulting in greater ability for the tissue to penetrate and fuse with the implant while also reducing the chances of infection and reducing the overall recovery time. In addition, by forming the dental drill with a relatively obtuse angulation between the termini of the drill flutes, the cutting forces are spread across a larger cutting area thus reducing wear on the drill itself. Moreover, by spreading the cutting force over a larger area, the heat generated by the drill is reduced and thus the discomfort afforded to the patient is reduced.

### TECHNICAL FIELD

The present disclosure generally relates to dental tools and, more particularly, relates to drills used for forming an osteotomy.

### BACKGROUND

Dental implants have become an increasingly common procedure for people needing tooth replacement as a result of a traumatic event, or through decay. With such a procedure, an osteotomy must first be performed to create an opening in the soft tissue of the gums and then ultimately into the bone of the jaw, either the upper or lower. Once the osteotomy is formed, an anchor portion of the implant is secured within the osteotomy after which other components can be built on top of the anchor, ultimately ending in an aesthetic crown or cap.

While effective, the osteotomy is typically formed by using a rotating drill bit extending from a drill which the dentist or oral surgeon manually positions and engages. As the soft tissue and even bone are relatively soft materials, the drill is typically provided with a cutting tip having a relatively narrow angulation. It is believed by the industry that such narrow angulation reduces wear on the drill and thus prolongs its life while at the same time reducing chatter, or vibrational kickback. Nonetheless, it is desired to have a drill bit which has an even greater usable lifetime over that which is currently available in the marketplace.

In addition, typical osteotomies are created with a tapered bottom if not an overall conical shape. This has typically been done to accommodate the generally tapered or conical shape of typical implants. However, more recent implants have more of a cylindrical shape and thus typical drills to not accommodate such implants. As a result, installation of cylindrical implants into more conically shaped osteotomies can lead to air pockets surrounding the implant. This not only invites bacteria and infection, but leads to more prolonged recovery times and thus discomfort for the patient.

### SUMMARY OF THE DISCLOSURE

In accordance with one aspect of the disclosure, an orthopedic drill bit is disclosed which may comprise a shaft, a spiral flute, and a cutting tip. The shaft may have a proximal and a distal end, the spiral flute extending along the shaft from the distal end to the proximal end. The cutting tip may be provided at the distal end. The cutting tip may also have first and second facets intersecting at an apex, with the apex forming an angle of at least 125°.

In accordance with another aspect of the disclosure, a method of forming a dental osteotomy is disclosed which may comprise providing a dental drill bit having a shaft, a spiral flute and a cutting tip, with the shaft having a proximal end and a distal end, the spiral flute extending along the shaft from the distal end to the proximal end, and the cutting tip being provided at the distal end. The cutting tip may have first and second facets intersecting at an apex, with the apex forming an angle of at least 125°. The method may include a second step of engaging the cutting edge with human tissue, the cutting edge removing tissue as it rotates.

In accordance with another aspect of the disclosure, the dental osteotomy kit is disclosed which may comprise a dental drill bit and a dental implant. The dental drill bit may have a shaft, a spiral flute and a cutting tip, with the shaft having a proximal end and distal end, and the spiral flute extending along the shaft from the distal end to the proximal end. The cutting tip may be provided at the distal end of the shaft and include first and second facets intersecting at an angle of at least 125°. The dental implant may have an apical end in the shape of the drill bit distal end.

These and other aspects and features of the disclosure will become more readily apparent upon reading the following detailed description when taken into conjunction with the accompanying drawings.

### BRIEF DESCRIPTION OF THE DRAWINGS

FIG. 1 is a side view of a dental drill constructed in accordance with the teachings of the disclosure;

FIG. 2 is an end view of the dental drill of FIG. 1;

FIG. 3 is a sectional view taken along the line 3-3 of FIG. 1;

FIG. 4 is an enlarged side view of the distal end of the drill of FIG. 1;

FIG. 5 is a side-by-side schematic showing the difference in angulation between the dental drill constructed in accordance with the teachings of the present disclosure and one constructed in accordance with the prior art;

FIG. 6 is a schematic representation of a dental implant positioned within an osteotomy formed by the dental drill of the present disclosure;

FIG. 7 is a schematic representation of an implant positioned within an osteotomy formed by a dental drill constructed in accordance with the prior art.

While the following detailed description has been given and will be provided with respect to certain specific embodiments, it is to be understood that the scope of the disclosure should not be limited to such embodiments, but that the same are provided simply for enablement and best mode purposes. The breath and spirit of the present disclosure is broader than the embodiments specifically disclosed and encompassed within the claims appended hereto.

### DETAILED DESCRIPTION

Referring now to FIG. 1, a dental drill bit constructed in accordance with the teachings of the disclosure is generally referred to by reference numeral 20. The drill bit 20 is designed to create an opening, or osteotomy, within gum and soft tissue and into the jaw bone of a patient. While not depicted, such a drill bit of course would be attached to a drill or other power tool used by a dentist or oral surgeon when surgically placing dental implants into a patient. In addition, while the drill bit 20 is shown as having certain dimensions, it is to be understood that the teachings of the disclosure can be used to create drill bits of different lengths and diameters as well. Finally, while the drill bit 20 is referred to herein as a dental drill bit, this is merely exemplary as the teachings of this disclosure can be used in any orthopedic procedure wherein osteotomies in any bone tissue may be needed.

Again with reference to FIG. 1, the drill bit 20 is shown to include a shaft 22 having a proximal end 24 and a distal end 26. As one of ordinary skill in the art will understand, the proximal end 24 is the end of the drill bit 20 which would be attached to the drill or other power tool used by the dentist or oral surgeon and thus includes a shank 28 to facilitate such attachment, such as by a chuck of a drill or the like.

The distal end 26 on the other hand includes cutting tip 30 as well has spiral flutes 32 sweeping away from the cutting tips 30 toward the proximal end 24. While the spiral flutes 32 may perform some cutting function in the sides of the osteotomy as well, they are primarily provided as means of transporting the soft tissue and bone fragments away from the osteotomy site during the procedure. While the teachings of this disclosure can be used to create a drill bit 20 with any desired dimension, the inventors have found that diameters ranging from 2.8 millimeters to 5.7 millimeters and lengths of around 40 millimeters (15-18 mm of which, for example, would be spiral flutes) can generally create osteotomies suitable for placement of dental implants in human anatomy.

Referring now to FIG. 2, it can be seen that the cutting tip 30 actually includes the termini 34 of three of the spiral flutes 32. In addition, each termini 34 includes first and second facets 36 and 38. Each of six facets 36 and 38 extend radially inward from an outer circumference 40 to a central apex 42. It is the edges of the facets 36 and 38 that serve as the main cutting surfaces of the drill bit 20.

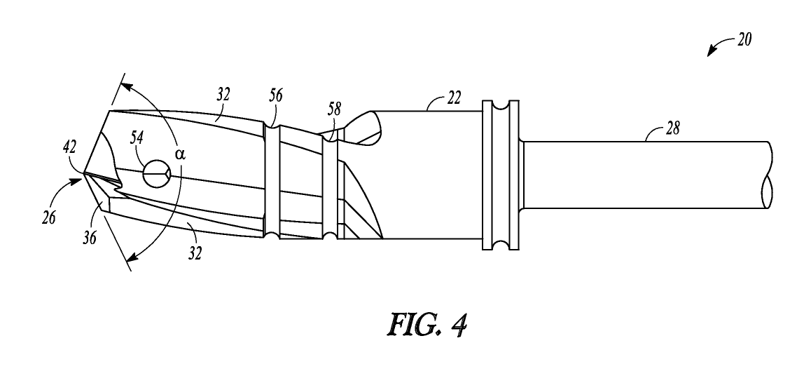

The angle, or angulation, at which the facets 36 and 38 extend from the apex 42 to the outer circumference 40 is of importance. As shown in each of FIG. 1 and FIG. 4, this angle or angulation between the facets of each flute termini 34 is much more obtuse than the prior art. For example, in the depicted embodiment, the angulation α is provided at 140°. This is in stark contrast to the typical angulation angles β provided by prior art drills which are often much more acute, e.g. 118° or less. Other angulation angles are certainly possible and encompassed within the scope of the present disclosure, such as but not limited to, 120°, 125°, 130°, 135°, 140°, 145° or even 150°.

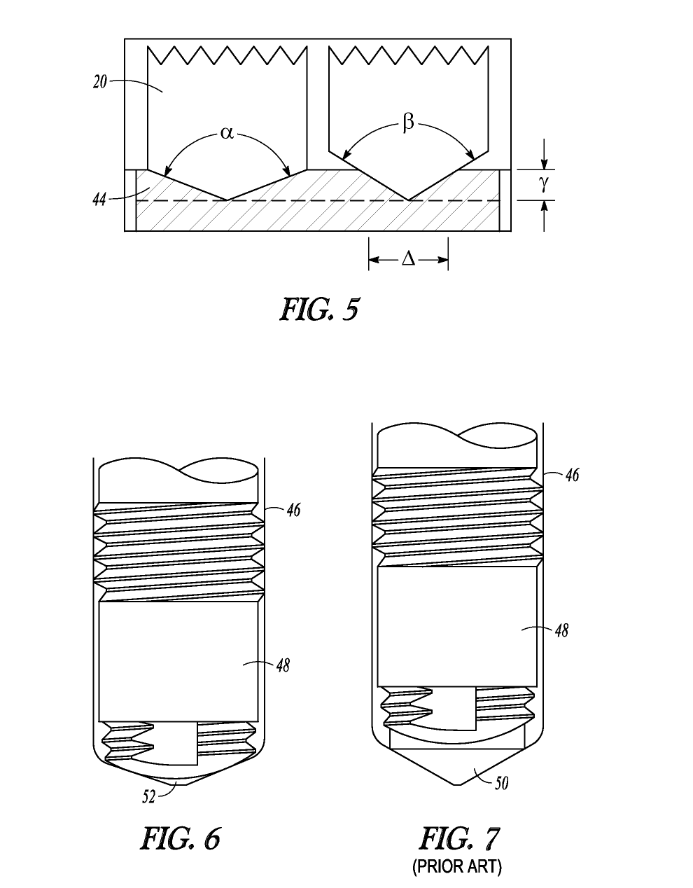

The impact of the angulation angle α is perhaps best depicted with reference to FIG. 5. As shown therein, with the prior art drill shown on the right hand side of FIG. 5, the angulation angle β is 118°, while in the presently disclosed drill 20, the angulation angle a is 140°. In so doing, it can be seen that at the same depth of penetration γ into tissue 44, the entirety of the cutting facets 36 and 38 of the presently disclosed drill bit 20 are in engagement with the tissue 44. With the prior art drill, on the other hand, only the central portion Δ of the cutting facets are in engagement with the tissue 44. The end result of these different designs is that with the present disclosure, a greater percentage of the cutting edge is always in engagement with the tissue thus spreading the cutting force over a larger cutting area and resulting in less wear. This in turn results in a longer lasting drill bit and thus more cost effectively performed osteotomies over time. In addition, by spreading the force over a larger cutting area, the amount of heat which is created by the drill is greatly reduced and thus the amount of heat transmitted to the surrounding tissue is greatly reduced. This in turn results in less discomfort for the patient and a decreased recovery time.

One additional benefit of having such a shallow angle of angulation a is that the overall depth of the osteotomy 46 which needs to be created to accommodate an implant 48 is greatly reduced. This is shown most effectively in a comparison between FIGS. 6 and 7. For example, with a prior art drill of FIG. 7, with its more narrow angulation β, the osteotomy 46 necessarily results in a relatively deep penetration into the tissue and bone as a result of the steep angular taper at the end of the drill. Once the implant 48 is inserted into such a prior art osteotomy 46, it can be seen that a significant amount of excess air space 50 remains in the osteotomy 46 which is not occupied by the implant 48 itself. Such excess air space 50 is not only inefficient, but invites intrusion of bacteria and results in increased infection risk. Even if infection is not generated, the recovery time is necessarily increased in that the excess air space 50 must be filled by replacement tissue by the human body.

With the osteotomy 46 formed by the present disclosure drill 20, on the other hand, it can be seen that when the implant 48 is fully inserted therein, a greatly reduced amount of air space 52 is created in that the osteotomy 46 much more closely matches the overall shape of the implant 48. In so doing, the drill 20 of the present disclosure not only affords a better fit for the implant 48, but also greatly reduced recovery time, lessened likelihood of infection, and a reduction in the tissue volume needed to successfully place the implant. Moreover, given the close match between the shape of the resulting osteotomy 46 and the implant 48, both may be sold or otherwise provided as a kit 51.

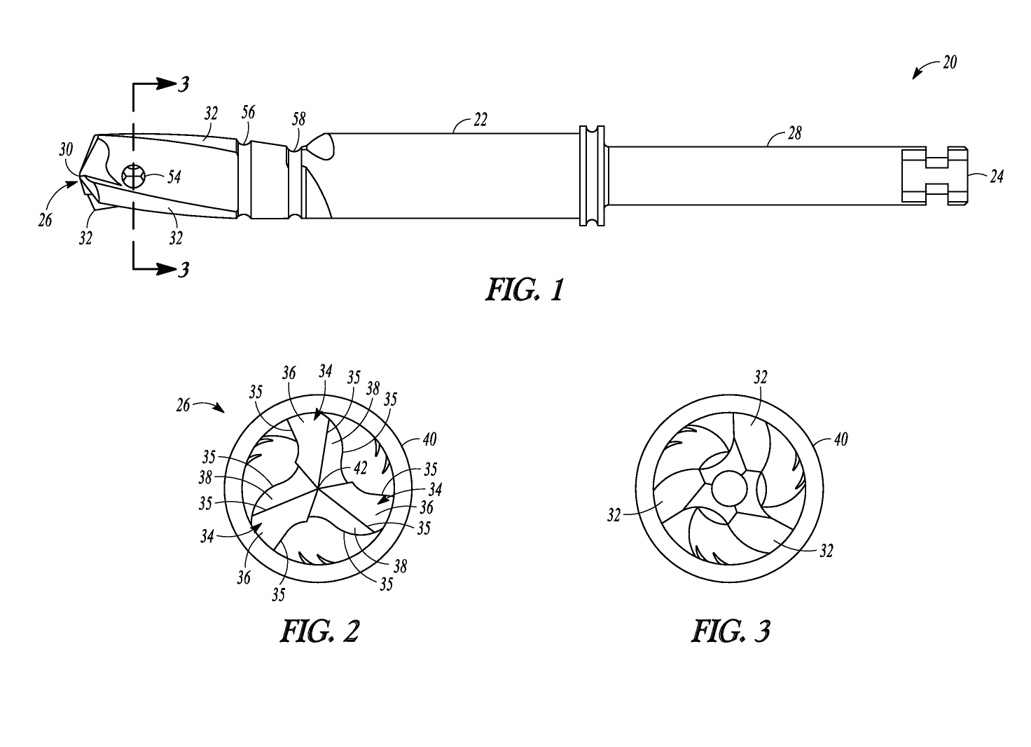

Referring again to FIG. 4, and now for the first time to FIG. 3, it can be seen that toward the distal end 26, an irrigation opening 54 is provided through each of the spiral flutes 32. The opening 54 enables cooling fluid such as water or saline to be communicated to the cutting facets 36, 38 to thus reduce the temperature of the drill and the osteotomy. In so doing, discomfort to the patient and recovery time are reduced. In addition, first and second circumferential bands 56 and 58 may be provided to provide for depth markers thus allowing the dentist and/or oral surgeon to accurately position the drill 20 and thus create an osteotomy 46 having the proper depth of penetration and dimension. The drill may also be manufactured from a range of materials such as, but not limited to, stainless steel and carbon steel alloys. One suitable example is stainless steel 465 alloy.

From the foregoing, it can be seen that the present disclosure sets forth a dental drill which results in an osteotomy having a lower overall depth than prior art osteotomies, a more cylindrical shape than prior art osteotomies, and a general form which more closely matches that of cylindrically shaped dental implants. In so with doing, the amount of excess space surrounding the dental implant once inserted in the osteotomy is reduced and thus the ability of the surrounding tissue to infiltrate and fuse with the implant is enhanced while also reducing the likelihood of infection, generally reducing overall recovery time, and allowing the implant to be placed in regions of reduced vertical tissue height.

In addition, Applicants wish to point out that the drill drastically departs from the general understanding of drill design. More specifically, it has been generally thought, and is still believed in the industry (both dental and heavy industry) today that when drilling in softer materials such as gum tissue and bone, relatively narrow angulations are desired to prolong drill serviceability and reduce chatter or vibration. Only with relatively hard materials such as metal, was it believed to be beneficial to use a more obtuse angulation. However, the inventors have found that this is not the case. As shown in the test data replicated in the charts and steps below, by increasing the angulation angle, the amount of chatter is greatly reduced while at the same time spreading the cutting force over a larger area thus reducing drill wear and increasing drill life.

### Testing Procedure

Axial force testing was performed on the drills 20 to determine their functional ability. It established that the force required to advance a reusable drill into a substrate at a constant rate/RPM over 25 cycles is a sufficient predictor of drill wear. Test setup and parameters were established similar to previously known drill analysis.

Acceptance of performance was based on the drills demonstrating force values equivalent to or less than the predicate device, indicating satisfactory cutting efficiency over wear and corrosive attack due to sterilization. Previous performance testing on drills demonstrated a standard deviation 0.2512 lbf within the same drill and test. As this was a released device with substantial clinical history, this amount of variation has assumed to be clinically insignificant. Thus, equivalence for this device was determined by 2-Sample t-tests detecting a difference of two standard deviations.

Using the previously derived standard deviation, a difference of two standard deviations, and a target power level of 80%, a minimum sample size of four drills was tested. As the testing process was resource intensive to repeat if sample size was deemed insufficient, six samples per drill design were tested from the beginning to ensure a sufficient power.

The drills were created to match a reduced length implant and minimize the amount of bone removed by each osteotomy. Two different variations on the drill were created. Group A (signified by the ‘A’ appended to the part number) modified the known drill design by removing the diameter ‘step’, reducing the height of the cutting flutes to a maximum effective cutting depth of 8 mmL, and adding a 6 mmL etch line. The distance of etch lines to drill tip in both groups was slightly reduced from the traditional distance, decreasing the amount of overdrill by 0.5 mm (from 1.25 to 0.75 mm). Group B (signified by the absence of the ‘A’ on the part number) added the same features as Group A, but also increased the cutting angle from 120° to 135°. Both groups had the same straight, non-cutting hub. Both groups utilize an identical, short length pilot drill, which retained the original 120° cutting tip. The pilot P/N did not feature an ‘A’ on the end of the P/N, as it is identical for both groups.

The surgical sequence of the existing drills resulted in the following diametrical bone displacement per drill, with a maximum bone displacement of 0.7 mm:

TABLE 1

| | | Prior Art Drill Protocol, | | | | | | | | | Max |
|---|---|---|---|---|---|---|---|---|---|---|---|
| | | Drill Diameter (mm) | | | | | | | | | Differ- |
| Implant | | | | 3.4/ | | 3.8/ | | 4.4/ | | 5.7/ | ential |
| Diameter | | 2.3 | 2.8 | 2.8 | 3.4 | 3.4 | 3.8 | 3.8 | 5.1 | 5.1 | (mm) |
| 3.7 mm | Soft | X | X | | | | | | | | 0.5 |
| | Bone | | | | | | | | | | |
| | Dense | X | | X | | | | | | | 0.6 |
| | Bone | | | | | | | | | | |
| 4.1 mm | Soft | X | X | | X | | | | | | 0.6 |
| | Bone | | | | | | | | | | |
| | Dense | X | X | | | X | | | | | 0.6 |
| | Bone | | | | | | | | | | |
| 4.7 mm | Soft | X | | X | | | X | | | | 0.6 |
| | Bone | | | | | | | | | | |
| | Dense | X | | X | | | | X | | | 0.6 |
| | Bone | | | | | | | | | | |
| 6.0 mm | Soft | X | | X | | | | X | X | | 0.7 |
| | Bone | | | | | | | | | | |
| | Dense | X | | X | | | | X | | X | 0.7 |
| | Bone | | | | | | | | | | |

By removing the step from the drill design, the straight drills no longer had the benefit of a stabilizing lead-in diameter. To ensure the drill resistance was the same as the predicate device, the surgical sequence for the drills was then modified to maintain the same maximum bone removal (0.7 mm).

The proposed existing surgical sequence for the drills resulted in the following diametrical bone displacement per drill:

TABLE 2

| | | | | | | | | | Max |
|---|---|---|---|---|---|---|---|---|---|
| | | Proposed Drill Protocol, | | | | | | | Differ- |
| Implant | | Drill Diameter (mm) | | | | | | | ential |
| Diameter | | 2.3 | 2.8 | 3.4 | 3.8 | 4.4 | 5.1 | 5.7 | (mm) |
| 3.7 mm | Soft | X | X | | | | | | 0.5 |
| | Bone | | | | | | | | |
| | Dense | X | X | X | | | | | 0.6 |
| | Bone | | | | | | | | |
| 4.1 mm | Soft | X | X | X | | | | | 0.6 |
| | Bone | | | | | | | | |
| | Dense | X | X | X | X | | | | 0.6 |
| | Bone | | | | | | | | |
| 4.7 mm | Soft | X | X | X | X | | | | 0.6 |
| | Bone | | | | | | | | |
| | Dense | X | X | X | X | X | | | 0.6 |
| | Bone | | | | | | | | |
| 6.0 mm | Soft | X | X | X | X | X | X | | 0.7 |
| | Bone | | | | | | | | |
| | Dense | X | X | X | X | X | X | X | 0.7 |
| | Bone | | | | | | | | |

As seen above, the proposed drilling protocol increased the number of drills required for placement of the larger implant lengths, but ensured a similar amount of bone was removed for each subsequent drill in the sequence. The amount of bone removed by the drill correlated with the amount of downward force needed to complete the osteotomy.

The surgical sequence had two different types of drills. First, the pilot drill (2.3) engaged the bone and drilled from the tip on to the edge of the cutting diameter, removing the full volume of bone. This engaged all cutting features on the tip (drill to edge). All subsequent drills drilled into the pilot osteotomy avoiding the center and cutting towards the edge of the drill.

The test designs in both groups A and B did not modify the cutting surface of the pilot drill leaving it identical to the predicate device. The overall drill length was reduced shortening the cutting flutes. Shortening the cutting flutes decreased the distance between the cutting edge of the drill and ejection area clearing bone chips more quickly. The changes had no potential for negative impact on the performance; the pilot drill was not tested.

For the remaining drill configurations, the worst-case was simulated by testing the drilling pair that removed the maximum amount of bone, magnifying any potential difference in cutting efficiency. Based on Table 1 and 2, the worst-case pairs were the 4.4/3.8 mm→5.7/5.1 mm of the predicate protocol, and the 4.4→5.1 mm drilling step in the proposed surgical protocol. Both of these steps removed 0.7 mm of bone from the previously drilled osteotomy.

Both Group A and Group B were tested along with the predicate device. All drills were tested in identical bone substrates. The test bed was a dense bone simulating material, as denser bone amplifies the resistance to the cutting edge that the drill will encounter, creating a worse case wear pattern. Bone-simulating foam, as opposed to natural bone, was utilized in order to provide a more homogenous test environment, reducing variation and allowing for a more precise evaluation. Because this test was a relative comparison of predicate and prototype (production equivalent) performance, natural bone was not required to verify functionality. The comparative substrate used to model clinically dense bone was polyurethane foam composed of a dense outer layer, representing cortical bone, pressed onto a solid rigid foam core, a model of trabecular bone. The outer layer had a density of 50 lb/ft³ (pcf) and the internal foam core a density of 30 pcf.

### Testing Methods

1.1. Testing was completed at the Zimmer Dental Test Lab (6221 El Camino Real, Carlsbad, Calif. 92009).

### 1.2. General Requirements

1.2.1. Drill specimens were manufactured by Orchid Unique and inspected to the provided prints by Zimmer Dental.

1.2.2. Specimens were tested as production part equivalents. The drills were processed in production identically to predicate devices. Individually packaged drills will be sold sterilized. Test samples will not be gamma sterilized, as metallic bonds are stable under irradiation and will not have any significant changes in mechanical properties.

1.2.3. The drill specimen engaged in the drilling handpiece was mounted to the load frame load cell. Bone foam was sectioned and placed.

1.2.4. Drill specimens were placed in a specimen bag after testing and labeled with sample number, date and test request number.

1.2.5. The operator used a numbered laboratory notebook to record experimental data.

1.2.6. Prior to testing, all drills were evaluated under a minimum of 40× magnification for surface finish defects. The test operator was instructed to notify the engineer overseeing the testing if damaged drills were found. No damaged drills were found.

1.2.7. The drill handpiece clamp was attached to the load cell. The drill handpiece was horizontal and centered in the fixture slot. The ram allowed space between the end of the drill and the material specimen.

1.2.8. Irrigation was not used for this testing to increase heat and wear on cutting edges of the drill.

1.2.9. Artificial bone block was the substrate used during testing.

1.2.10. The ram speed was set at 0.2 inches per minute.

1.2.11. The rotational speed of the drills was 800±25 rpm.

1.2.12. Each drill was tested by drilling to the 8 mmL etch mark. This allowed for evaluation of the entire cutting length of the drills while matching the shortest etched length of the predicate design.

1.2.13. Data was collected at 10 Hz. A 20 point moving average was applied to filter the vibration noise of the drill.

1.2.14. The second drill of each pair was tested by drilling into the hole at the same spot where the smaller diameter drill was used.

1.2.15. The step drills were tested by drilling into the hole created by the appropriate drill size as per current surgical protocol, or based on proposed surgical protocol specified above.

1.2.16. Each drill was tested until measurements were taken on the 25th site.

1.3. Force Testing Sequence—Measurements at the 1^{st} and 25^{th} drill sites

1.3.1. Test drills were grouped as either “A” or “B”.

1.3.2. Drills of the same size and grouping were labeled 1-6.

1.3.3. 1^{st} force measurements were measured from the same source bone block. All ²⁵th force measurements were measured from the same source bone block. Drill sites 2-24 were made with other bone blocks of the same P/N and density.

1.3.4. The 4.4 mm (test drills) or 4.4/3.8 mm (predicate drills) prepared the initial osteotomies (1-25) in the bone blocks. No force measurements were taken.

1.3.5. The 5.1 mm (test drills) or 5.7/5.1 mm (predicate drills) engaged the 4.4 and 4.4/3.8 mm osteotomies, respectively, for increments 1-25. The force measurements were taken at the 1^{st} and 25^{th} measurement, but the 5.1 and 5.7/5.1 mm drills simulated use by engaging unused 4.4 mm and 4.4/3.8 mm osteotomies for increments 2-24.

1.3.6. Site 1: One hole was drilled into specified bone block sample to a depth of 8 mm with each drill of each test type. The force vs. distance was recorded, capturing the maximum force value for comparison purposes.

1.3.7. Each drill was autoclaved for 80 minutes at 121° C. at 15-20 psi.

1.3.8. Repeat drilling and autoclaving for each test type 24 times, and record information for drill site 25.

Based on the foregoing, the following summarization chart was compiled showing the improved performance of the drill disclosed herein.

TABLE 3
Axial Force Values

| | | | |
|---|---|---|---|
| | Force | | |
| Sample | (lbf) | Average | StdDev |

1^{st} Drill Site

| | | | |
|---|---|---|---|
| P1 | 0.312 | 0.318 | 0.051 |
| P2 | 0.333 | | |
| P3 | 0.306 | | |
| P4 | 0.236 | | |
| P5 | 0.393 | | |
| P6 | 0.330 | | |
| A1 | 0.464 | 0.285 | 0.093 |
| A2 | 0.228 | | |
| A3 | 0.306 | | |
| A4 | 0.262 | | |
| A5 | 0.224 | | |
| A6 | 0.225 | | |
| B1 | 0.296 | 0.247 | 0.034 |
| B2 | 0.254 | | |
| B3 | 0.268 | | |
| B4 | 0.240 | | |
| B5 | 0.200 | | |
| B6 | 0.223 | | |

25^{th} Drill Site

| | | | |
|---|---|---|---|
| P1 | 0.315 | 0.311 | 0.063 |
| P2 | 0.311 | | |
| P3 | 0.243 | | |
| P4 | 0.255 | | |
| P5 | 0.420 | | |
| P6 | 0.323 | | |
| A1 | 0.522 | 0.377 | 0.144 |
| A2 | 0.400 | | |
| A3 | 0.488 | | |
| A4 | 0.442 | | |
| A5 | 0.256 | | |
| A6 | 0.152 | | |
| B1 | 0.329 | 0.269 | 0.045 |
| B2 | 0.283 | | |
| B3 | 0.263 | | |
| B4 | 0.303 | | |
| B5 | 0.208 | | |
| B6 | 0.230 | | |

### INDUSTRIAL APPLICABILITY

The present disclosure can find industrial applicability in many situations including medical or dental procedures wherein a generally cylindrical opening needs to be formed in human tissue. Using dental procedures as an example, an osteotomy often needs to be performed within the gum and bone of the human jaw and the dental drill set forth in the pending disclosure allows for such an osteotomy to be created in a manner which much more closely matches the generally cylindrical shape of modern dental implants. For the patient this reduces infection risk, discomfort, and recovery time, and for the dentist or oral surgeon this reduces the wear imparted to the drill itself and thus increases its serviceable life.

1-7. (canceled)

8. A method of implanting a dental implant comprising:
engaging an orthopedic drill bit with tissue, including engaging a cutting tip having an apex, located at a shaft distal end and comprising an angulation of at least 125°, with the tissue;
rotating the orthopedic drill bit;
removing the tissue by way of one or more spiral flutes, extending from the shaft distal end, as the orthopedic drill bit is rotated;
forming an orofacial cavity having a size and shape that substantially matches a portion of the drill bit; and
implanting, into at least a portion of the orofacial cavity, a dental implant having an apical end including a size or shape substantially matching the size or shape of the portion of the distal end of the dental drill bit.

9. The method of claim 8, wherein removing the orthopedic drill bit with tissue includes engaging a cutting tip having an apex, comprising an angulation of at least 130°, with the tissue.

10. The method of claim 8, wherein removing the orthopedic drill bit with tissue includes engaging a cutting tip having an apex, comprising an angulation of at least 140°, with the tissue.

11. The method of claim 8, wherein removing the orthopedic drill bit with tissue includes inserting a shaft having a uniform diameter, from a proximal end to the distal end, into a mouth.

12. The method of claim 8, wherein removing the orthopedic drill bit with tissue includes inserting a shaft distal end having a length of 25 millimeters or less into a mouth.

13-14. (canceled)

15. The method of claim 14, wherein implanting the dental implant includes abutting an apical end of the dental implant and a base of the orofacial cavity formed by the apex.

16. An osteotomy system, comprising:
a dental drill bit having a shaft, a spiral flute,, and a cutting tip, the shaft having a proximal end and a distal end, the spiral flute extending along a portion of the shaft from the distal end toward the proximal end, and the cutting tip located at the distal end, the cutting tip having first and second facets intersecting at an apex and forming an angulation of at least 120°; and
a dental implant having an apical end including a size or shape substantially matching a size or shape of the distal end of the dental drill bit.

17. The osteotomy system of claim 16, wherein the angulation, formed between the first and second facets, is at least 130°.

18. The osteotomy system of claim 16, wherein the angulation, formed between the first and second facets, is at least 140°.

19. The osteotomy system of claim 16, wherein the shaft has a uniform constant diameter from the proximal end to the distal end.

20. The osteotomy system of claim 16, wherein the distal end of the shaft has a length of 25 millimeters or less.

21. The osteotomy system of claim 16, wherein the spiral flute includes an irrigation opening configured to communicate a cooling fluid to the cutting tip.

22. The osteotomy system of claim 21, wherein the cooling fluid is saline.

23. The osteotomy system of claim 16, wherein the dental drill bit includes at least one circumferential depth marker band.

24. The method of claim 8, further comprising communicating a cooling fluid to the cutting tip by an irrigation opening of at least one of the one or more spiral flutes.

25. The method of claim 24, wherein the cooling fluid includes at least water.

26. The method of claim 8, wherein forming the orofacial cavity includes removing the tissue to a desired depth indicated by at least one circumferential depth marker band of the dental drill bit.

27. The method of claim 8, wherein the tissue engaged with the orthopedic drill bit is located in a region of reduced vertical tissue height relative to other regions of a patient's mouth.

28. The method of claim 8, wherein removing the tissue includes contacting a substantial entirety of a first and a second cutting facet with the tissue, the first and the second cutting facet defining the cutting tip.
